(19) United States
(12) Patent Application Publication
(10) Pub. No.: US 2020/0126358 A1
(43) Pub. Date: Apr. 23, 2020

(54) GAMING SYSTEM HAVING AN AWARD AGGREGATION SERVER

(71) Applicant: IGT, Las Vegas, NV (US)

(72) Inventors: Fei Yi, Beijing (CN); Xianfeng Ma, Beijing (CN)

(21) Appl. No.: 16/166,489

(22) Filed: Oct. 22, 2018

(51) Int. Cl. G07F 17/32

(52) U.S. Cl. CPC G07F 17/3258; G07F 17/3223; G07F 17/3239

(57) ABSTRACT

A system is capable of receiving event information related to events that occur within the gaming system, managing an electronic record representing a player profile within the gaming system, and updating the electronic record with a first value representing a first mini bonus in response to a first event occurring for the player within the gaming system, update the electronic record with a second value representing a second mini bonus in response to a second event occurring for the player within the gaming system, and update the electronic record with a third value representing a jackpot award in response to determining that a plurality of events occur for the player within the gaming system and within a predetermined period of time.

### BACKGROUND

The present disclosure relates generally to gaming systems and, in particular, to bonus aggregation in a gaming system.

Casinos may use bonuses to attract players and to increase player loyalty. Generally speaking, the chances of a player winning a large bonus or a jackpot bonus are rare, especially when compared to the chances a player has to win other smaller awards and prizes.

### BRIEF SUMMARY

In certain embodiments, the present disclosure relates to a gaming system in which awards, such as bonuses or mini bonuses, are capable of being aggregated by an aggregation server. In some embodiments, a method of bonus aggregation is provided that includes: creating, by a gaming system, a player profile comprising player identification information and a wager account record for the player; establishing, by the gaming system, a plurality of events to occur for the player; establishing, by the gaming system, a predetermined period of time in which, if the plurality of events occur, the wager account record for the player will be incremented by a value representing a first predetermined award; determining, by the gaming system, that a first event in the plurality of events occurs for the player within the predetermined period of time; in response to determining that the first event occurs for the player within the predetermined period of time, incrementing, by the gaming system, the wager account record for the player by a value representing a second predetermined award that is less than the value representing the first predetermined award; and updating, by the gaming system, the player profile to indicate that the first event occurred for the player within the predetermined period of time.

In some embodiments, a bonus aggregation server is provided that includes: a communication interface that facilitates machine-to-machine communications; a processor coupled to the communication interface; and a computer-readable storage medium coupled to the processor and having instructions that are executable by the processor. In various embodiments, the instructions may include a set of instructions that receive event information related to events that occur within a gaming system; a set of instructions that manage an electronic record representing a player profile within the gaming system; and a set of awarding instructions that update the electronic record with a first value representing a first predetermined award if a predetermined plurality of events are determined to occur for the player within the gaming system, where the set of awarding instructions also update the electronic record with a second value representing a second predetermined award if a first event in the plurality of events occurs within the predetermined period of time, where the second value representing the second predetermined award is no larger than the first value representing the first predetermined award.

In some embodiments, a system is provided that includes: a communication interface that facilitates machine-to-machine communications; a processor coupled to the communication interface; and a computer-readable storage medium coupled to the processor and having instructions that are executable by the processor. In various embodiments, the instructions include a set of instructions that receive event information related to events that occur within a gaming system; a set of instructions that manage an electronic record representing a player profile within the gaming system; and a set of awarding instructions that update the electronic record with a first value representing a first predetermined award if a predetermined plurality of events are determined to occur for the player within the gaming system, where the set of awarding instructions also update the electronic record with a second value representing a second predetermined award if a first event in the plurality of events occurs within the predetermined period of time, where the second value representing the second predetermined award is no larger than the first value representing the first predetermined award.

Additional features are described herein and will be apparent from the following Description and the figures.

### BRIEF DESCRIPTION OF THE SEVERAL VIEWS OF THE DRAWINGS

FIG. 1 is a block diagram of a gaming system accordance with embodiments of the present disclosure;

FIG. 2 is a block diagram depicting additional aspects of a gaming system in accordance with embodiments of the present disclosure;

FIG. 3 is a block diagram depicting details of an electronic gaming machine in accordance with embodiments of the present disclosure;

FIG. 4 is a block diagram depicting an illustrative data structure used in a player profile database in accordance with embodiments of the present disclosure;

FIG. 5 is a flow diagram depicting a method of performing bonus aggregation in accordance with embodiments of the present disclosure;

FIG. 6 is a flow diagram depicting another method of performing bonus aggregation in accordance with embodiments of the present disclosure;

FIG. 7 is a block diagram depicting additional details of a gaming system in accordance with embodiments of the present disclosure; and

FIG. 8 is a flow diagram depicting another method of performing bonus aggregation in accordance with embodiments of the present disclosure.

### DETAILED DESCRIPTION

Embodiments of the present disclosure will be described in connection with a gaming system having one or multiple user devices that enable gaming activity. While certain embodiments of the present disclosure will reference the use of an Electronic Gaming Machine (EGM) as a device that enables players to participate in gaming activity, it should be appreciated that embodiments of the present disclosure are not so limited. For instance, any computing device, personal gaming device, or collection of computing devices may be used to facilitate player engagement with a gaming system.

Embodiments of the present disclosure will be described in connection with a gaming system that is capable of improving player experiences, while also enabling various players to participate in a number of different events. In some embodiments, the improved player experience may result in increased player loyalty due to the fact that the players have more opportunities to win and a more continuous player engagement is achieved. Devices that enable such an improved player experience may be more desirable than devices and systems that simply adhere to old jackpot systems where the odds of winning the jackpot are relatively limited.

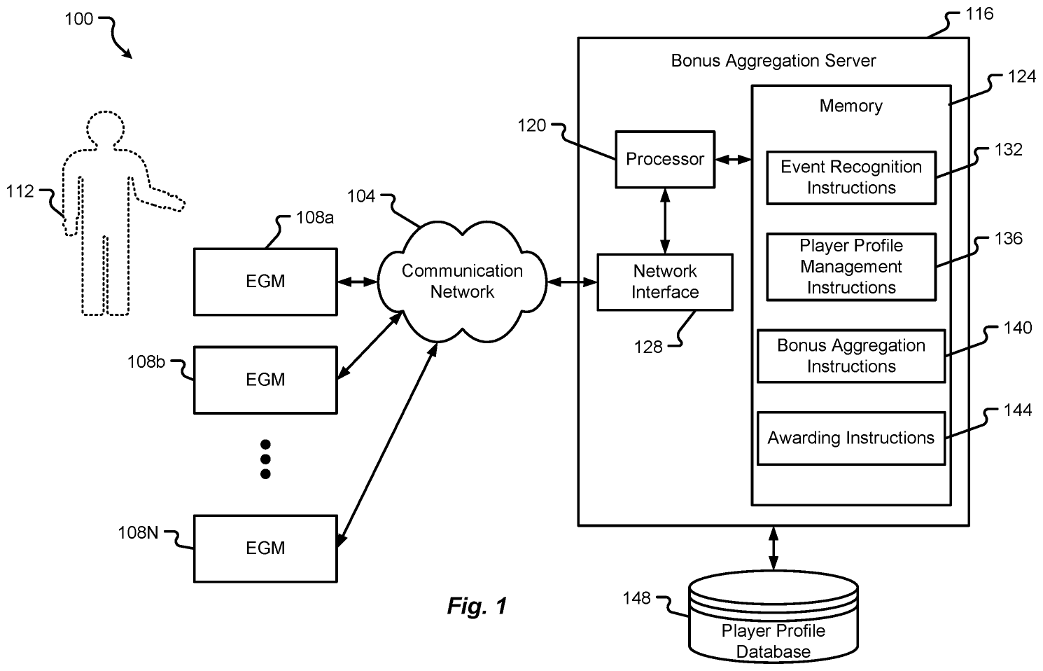

With reference initially to FIG. 1, details of an illustrative gaming system 100 will be described in accordance with at least some embodiments of the present disclosure. The components of the gaming system 100, while depicted as having particular instruction sets and devices, is not necessarily limited to the examples depicted herein. Rather, a system according to embodiments of the present disclosure may include one, some, or all of the components depicted in the system 100 and does not necessarily have to include all of the components in a single device. For instance, the components of a server may be distributed amongst a plurality of servers and/or other devices (e.g., an EGM, portable user device, etc.) in the system 100 without departing from the scope of the present disclosure.

The gaming system 100 is shown to include a communication network 104 that interconnects and facilitates machine-to-machine communications between one or multiple EGMs 108a-N and a bonus aggregation server 116. It should be appreciated that the communication network 104 may correspond to one or many communication networks without departing from the scope of the present disclosure. In some embodiments, the various EGMs 108a-N and server(s) 116 may be configured to communicate using various nodes or components of the communication network 104. The communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, the EGMs 108a-N may be distributed throughout a single property or premises (e.g., a single casino floor) or the EGMs 108a-N may be distributed among a plurality of different properties. In a situation where the EGMs 108a-N are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The EGMs 108a-N may utilize the same or different types of communication protocols to connect with the communication network 104. It should also be appreciated that the EGMs 108a-N may or may not present the same type of game to a player 112. For instance, the first EGM 108a may correspond to a gaming machine that presents a slot game to the player 112, the second EGM 108b may correspond to a video poker machine, and other EGMs may present other types of games or a plurality of different games for selection and eventual play by the player 112. It may be possible for the EGMs 108a-N to communicate with one another via the communication network 104. In some embodiments, one or more of the EGMs 108a-N may only be configured to communicate with a centralized management server and/or the bonus aggregation server 116. Although not depicted, the system 100 may include a separate server or collection of servers that are responsible for managing the operation of the various EGMs 108a-N in the gaming system 100. It should also be appreciated that the bonus aggregation server 116 may or may not be co-located with one or more EGMs 108a-N in the same property or premises. Thus, one or more EGMs 108a-N may communicate with the bonus aggregation server 116 over a WAN, such as the Internet. In such an event, a tunneling protocol or Virtual Private Network (VPN) may be established over some of the communication network 104 to ensure that communications between an EGM and a remotely-located server 116 are secured.

The bonus aggregation server 116 is further shown to include a processor 120, memory 124, and a network interface 128. These resources may enable functionality of the bonus aggregation server 116 as will be described herein. For instance, the network interface 128 provides the server 116 with the ability to send and receive communication packets or the like over the communication network 104. The network interface 128 may be provided as a network interface card (NIC), a network port, drivers for the same, and the like. Communications between the components of the server 116 and other devices connected to the communication network 104 may all flow through the network interface 128.

The processor 120 may correspond to one or many computer processing devices. For instance, the processor 120 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 120 may be provided as a microprocessor, Central Processing Unit (CPU), plurality of microprocessors, microcontroller, or plurality of microcontrollers that are configured to execute the instructions sets stored in memory 124. Upon executing the instruction sets stored in memory 124, the processor 120 enables various authentication functions of the bonus aggregation server 116.

The memory 124 may include any type of computer memory device or collection of computer memory devices. The memory 124 may be volatile or non-volatile in nature and may include one or many different types of memory devices. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. Although not depicted, the memory 124 may include instructions that enable the processor 120 to store data into a player profile database 148 and retrieve information from the player profile database 148. Alternatively or additionally, the player profile database 148 or data stored therein may be stored internal to the server 116 (e.g., within the memory 124 of the server 116 rather than in a separate database).

The illustrative instruction sets that may be stored in memory 124 include, without limitation, an event recognition instruction set 132, a player profile management instruction set 136, a bonus aggregation instruction set 140, and an awarding instruction set 144. Functions of the server 116 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the server 116. Said another way, the particular instruction sets depicted in FIG. 1 should not be construed as limiting embodiments described herein.

In some embodiments, the event recognition instruction set 132, when executed by the processor 120, may enable the bonus aggregation server 116 to receive a communication that indicates an event has occurred within the gaming system 100, receive one or more communications that indicate multiple events have occurred within the gaming system 100, categorize events and event information, determine whether an event corresponds to a triggering event that will initiate some other process within the server 116, and so on. In some embodiments, an output of the event recognition instruction set 132 may be provided as an input to one or more other instruction sets in the memory 124. For example, if the event recognition instruction set 132 determines that an event has occurred within the gaming system 100 and the event is one of a plurality of events that may cause the server 116 to issue a jackpot award, the event recognition instruction set 132 may notify the player profile management instruction set 136, the bonus aggregation instruction set 140, and/or the awarding instruction set 144.

The player profile management instruction set 136, when executed by the processor 120, may enable the bonus aggregation server 116 to manage one or more data fields for a player profile stored in the player profile database 148 and/or cause an EGM 108a-N to update an appropriate credit meter for the player 112 within the EGM being played by the player 112. In some embodiments, the player profile management instruction set 136 may be configured to create one or more player profiles and associated data structures within the player profile database 148. A player profile, in some embodiments, may include player identification information and a wager account record for the player 112. In some embodiments, the player profile management instruction set 136 may be responsible for managing electronic records of all players within the gaming system 100 or a subset of players within the gaming system 100. In some embodiments, the player profile management instruction set 136 may be responsible for updating a player profile to indicate that an associated player 112 is attempting to earn a bonus or jackpot based on an aggregation of events that can occur within the gaming system 100. The player profile management instruction set 136 may be configured to work in synchronization with the bonus aggregation instruction set 140 and/or awarding instruction set 144 to update a player profile in response to a player 112 completing one or a plurality of events defined for the bonus or jackpot based on the aggregation of events that can occur within the gaming system 100.

In some embodiments, the bonus aggregation instruction set 140, when executed by the processor 120, may enable the bonus aggregation server 116 to establish or define, within a player profile, a plurality of events to occur for the player 112 and a predetermined amount of time in which, if the plurality of events occur, the wager account record for the player will be updated. The bonus aggregation instruction set 140 may also, in some embodiments, define award or bonus values to assign to a particular player's 112 player profile if the player 112 accomplishes an event in the plurality of events. Likewise, the bonus aggregation instruction set 140 may define award, bonus, or jackpot values to assign to a particular player's 112 player profile if the player 112 accomplishes all of the plurality of events within the predetermined amount of time.

In some embodiments, the awarding instruction set 144, when executed by the processor 120, may enable the bonus aggregation server 116 to update an electronic record in the player profile database 148 for a particular player's 112 player profile if the player 112 is determined to have won a bonus, award, jackpot, or the like. Specifically, the awarding instruction set 144 may be responsible for updating electronic records in the player profile database 148 with various values representing predetermined awards when predetermined events occur. Even more specifically, the awarding instruction set 144 may be configured to update the electronic record with a first value representing a first predetermined award (e.g., corresponding to a jackpot, large bonus, or the like) if the predetermined plurality of events are determined to occur for the player 112 within the gaming system 100 within the predetermined period of time. This functionality may require some communication between the awarding instruction set 144 and the other instruction sets stored in memory 124. The awarding instruction set 144 may also be configured to update the electronic record for the player 112 with a second value representing a second predetermined award if one, but not all, of the plurality of events defined within the player profile are determined to occur within the predetermined period of time. In some embodiments, the second value representing the second predetermined award is no larger than the first value representing the first predetermined award. As a more specific example, the second value representing the second predetermined award may be a mini bonus that is added to the player profile responsive to the individual event occurring whereas the first value representing the first predetermined award may correspond to a jackpot or larger bonus that is added to the player profile responsive to all of the plurality of events occurring. In some embodiments, a jackpot may correspond to a largest possible prize or award. In some embodiments, a large bonus may correspond to a prize or award that is larger in value or size than a mini bonus as discussed herein. The term bonus or mini bonus may be used to refer to an award or prize that is smaller in value or size than a jackpot and a large bonus. In some embodiments, the bonus or mini bonus may be awarded from a prize pool that is used to also fund the large bonus or jackpot whereas, in other embodiments, the bonus or mini bonus may be awarded from a separate prize pool. In some embodiments, a mini bonus may be smaller in value or size than a bonus and may or may not be funded from the same prize pool that is used to fund the bonus. A mini bonus, as a non-limiting example, may correspond to a non-monetary prize, such as a free spin or an additional game play opportunity whereas a bonus may correspond to a monetary prize or game play credit that is redeemable as cash. In some embodiments, the mini bonus may correspond to a monetary prize or award, but the size of the mini bonus may still be less than a size of a bonus, both of which may be less than a size of a large bonus or jackpot.

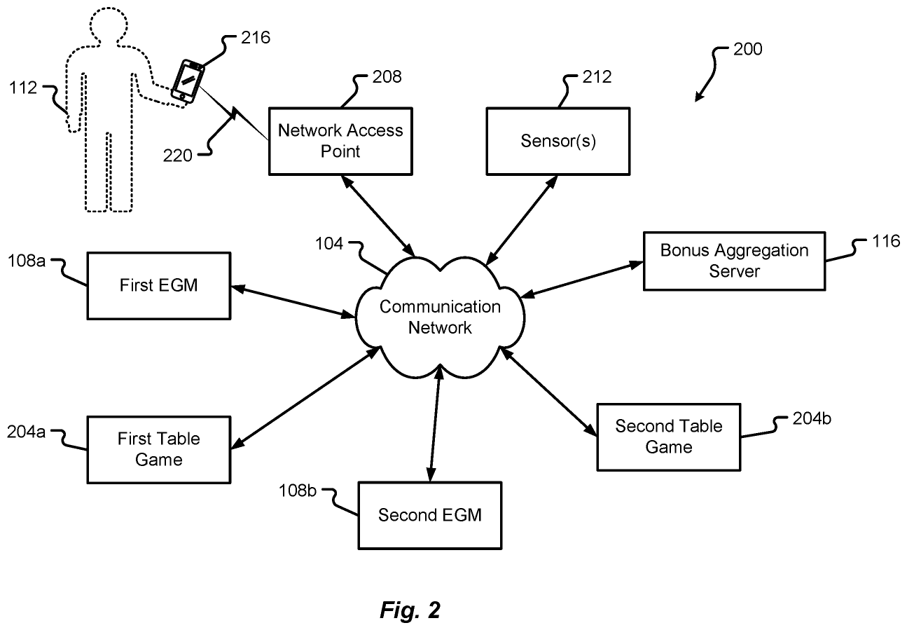

With reference now to FIG. 2, additional details of the gaming system 200 will be described in accordance with at least some embodiments of the present disclosure. The gaming system 200 may be similar or identical to the gaming system 100 depicted in FIG. 1. In some embodiments, the gaming system 200 may utilize the communication network 104 to facilitate communications between various nodes of the gaming system 200. Non-limiting examples of the nodes that may belong to the gaming system 200 include the EGMs 108a-N or components within the EGMs 108a-N, the bonus aggregation server 116, one or more table games 204a, 204b, network access points 208, and one or more sensors 212. The gaming system 200 may also include a mobile user device 216, which may be enabled to connect with the communication network 104 via a network access point 208. When connected with the communication network 104, the mobile user device 216 may also be considered a need in the system 200.

In some embodiments, some of the EGMs, such as the first EGM 108a and some of the table games, such as the first table game 204a may be located at a first property or premises (e.g., within a first casino building). Other EGMs, such as the second EGM 108b and other table games, such as the second table game 204b may be located at a second property or premises (e.g., within a second casino building). These different properties or premises may be owned by a common entity or may be owned by different entities. As will be discussed in further detail herein, the player 112 may be required to visit different properties or locations within the same property. Such visitations of different locations may correspond to a predetermined event in the plurality of predetermined events. In some embodiments, two events in the plurality of predetermined events may require the player 112 to play an EGM 108a or table game 204a at a first property as well as play an EGM 108b or table game 204b at a second property. Responsive to the player 112 making a wager at a particular EGM 108a, 108b and a particular table game 204a, 204b, the events may be reported to the event recognition instructions 132 within the bonus aggregation server 116 to indicate that the player 112 has completed the two events.

In addition to defining predetermined events to correspond to the player 112 placing a wager with a particular EGM or table game, embodiments of the present disclosure also contemplate that some events in the predetermined plurality of events may correspond to requiring the player 112 to visit a particular location in a casino or play a particular game on their mobile user device 216. A player's 112 position within a casino property may be correlated to a predetermined location if the player's 112 mobile user device 216 establishes a communication link 220 with a predetermined network access point 208. Alternatively or additionally, one or more sensors 212 within a casino property may be used to track a position of the player 112 or a position of the player's 112 mobile user device 216. Non-limiting examples of sensors 112 that may be used to determine a player's 112 position within a casino or property may include cameras, video cameras, image sensors, proximity sensors, pressure sensors, beacons, etc. The sensors 212 may be used to determine that a player 112 has visiting a predetermined location in a property for purposes of determining whether an event has occurred.

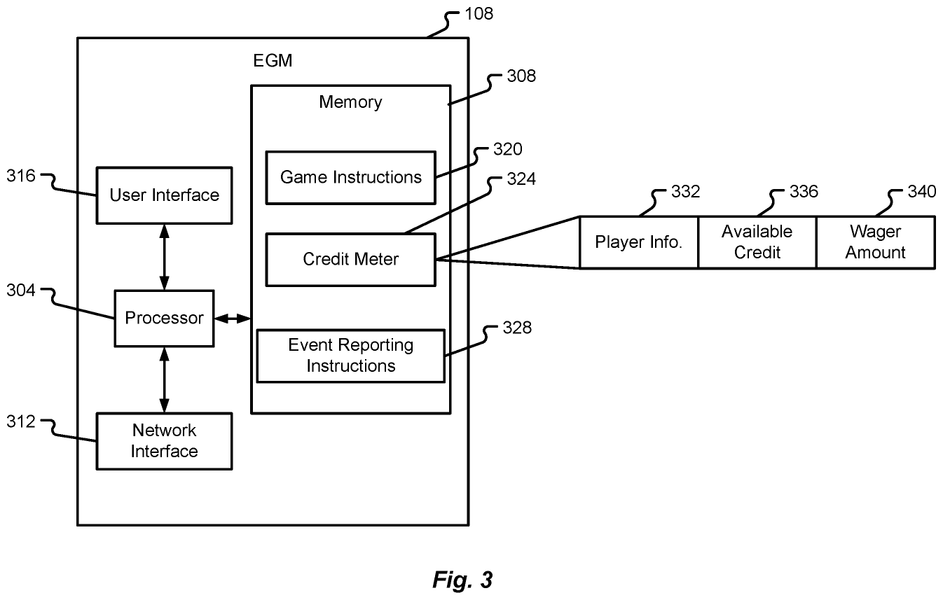

With reference now to FIG. 3, additional details of an EGM 108 will be described in accordance with at least some embodiments of the present disclosure. While depicted as an EGM 108, it should be appreciated that some or all of the components of the EGM 108 may be included in a player's 112 mobile user device 216 without departing from the scope of the present disclosure.

The EGM 108 is depicted to include a processor 304, memory 308, a network interface 312, and a user interface 316. In some embodiments, the processor 304 may be similar or identical to the processor 120. In other words, the processor 304 may correspond to one or many microprocessors, CPUs, microcontrollers, or the like. The processor 304 may be configured to execute one or more instruction sets stored in memory 308.

The network interface 312 may also be similar or identical to network interface 128. The nature of the network interface 312, however, may depend upon whether the network interface 312 is provided in an EGM 108 or a mobile user device 216. Examples of a suitable network interface 312 include, without limitation, an Ethernet port, a USB port, an RS-232 port, an RS-485 port, a NIC, an antenna, a driver circuit, a modulator/demodulator, etc. The network interface 312 may include one or multiple different network interfaces depending upon whether the EGM 108 is connecting to a single communication network 104 or multiple different types of communication networks 104. For instance, the EGM 108 may be provided with both a wired network interface and a wireless network interface without departing from the scope of the present disclosure.

The user interface 316 may correspond to any type of input and/or output device that enables the player 112 to interact with the EGM 108. As can be appreciated, the nature of the user interface 316 may depend upon the nature of the EGM 108. For instance, if the EGM 108 is a traditional mechanical reel slot machine, then the user interface 316 may include one or more mechanical reels with symbols provided thereon, one or more lights or LED displays, one or more depressible buttons, a lever or “one armed bandit handle”, a speaker, or combinations thereof. If the EGM 108 is a digital device, then the user interface 316 may include one or more touch-sensitive displays, LED/LCD display screens, etc.

The memory 308 may be similar or identical to memory 124. For instance, the memory 308 may include one or multiple computer memory devices that are volatile or non-volatile. The memory 308 may be configured to store instruction sets that enable player interaction with the EGM 108, that enable game play at the EGM 108, and/or that enable coordination with the bonus aggregation server 116. Examples of instruction sets that may be stored in the memory 308 include a game instruction set 320, a credit meter 324, and event reporting instructions 328. In some embodiments, the game instructions 320, when executed by the processor 304, may enable the EGM 108 to facilitate one or more games of chance or skill and produce interactions between the player 112 and the game of chance or skill. In some embodiments, the game instructions 320 may include subroutines that present one or more graphics to the player 112 via the user interface 316, subroutines that calculate whether a particular wager has resulted in a win or loss during the game of chance or skill, subroutines for determining payouts for the player 112 in the event of a win, subroutines for exchanging communications with a connected server (e.g., game management server, bonus aggregation server 116, or the like), subroutines for enabling the player 112 to engage in a game using their mobile user device 216, and any other subroutine or set of instructions that facilitate gameplay at or in association with the EGM 108.

The credit meter 324 may correspond to a secure instruction set within the EGM 108 that facilitates a tracking of activity at the EGM 108. In some embodiments, the credit meter 324 may be used to store or log information related to various player 112 activities and events that occur at the EGM 108. The types of information that may be maintained in the credit meter 324 include, without limitation, player information 332, available credit information 336, wager amount information 340, and other types of information that may or may not need to be recorded for purposes of accounting for wagers placed at the EGM 108 and payouts made for a player 112 during a game of chance or skill played at the EGM 108. In some embodiments, the credit meter 324 may be configured to track coin in activity, coin out activity, coin drop activity, jackpot paid activity, mini bonus paid activity, credits applied activity, external bonus payout activity, voucher in activity, voucher out activity, timing of events that occur at the EGM 108, and the like. In some embodiments, certain portions of the credit meter 324 may be updated in response to outcomes of a game of chance or skill played at the EGM 108. Some or all of the data within the credit meter 324 may be reported to the bonus aggregation server 116, for example, if such data applies to an event belonging to a plurality of events being tracked for a player 112 by the bonus aggregation server 116. As an example, the number, value, and timing of wagers placed by a particular player 112 and payouts on such wagers may be reported to the bonus aggregation server 116 if any of such information applies to a plurality of events being tracked by the bonus aggregation server 116.

Reporting of events by the EGM 108 may be facilitated by execution of the event reporting instruction set 328 by the processor 304. In some embodiments, the event reporting instructions 328 may enable the EGM 108 to report various types of information related to activity at the EGM 108. For instance, the event reporting instruction set 328 may be configured to enable the EGM 108 to report when a player 112 is playing a game at the EGM 108, an identity of the player 112 at the EGM 108, wagers placed by the player 112, payouts made to the player 112 at the EGM 108, odds associated with payouts made to the player 112, additional bonuses or mini bonuses paid to the player 112, and so on. The event reporting instruction set 328 may also include instructions that enable the EGM 108 to format reporting messages for transmission across the communication network 104 to the bonus aggregation server 116 or other servers in the gaming system 100, 200. As can be appreciated, the event reporting instructions 328 may be triggered to generate and send a reporting message based on outputs of the game instruction set 320 and/or activities that occur at the credit meter 324.

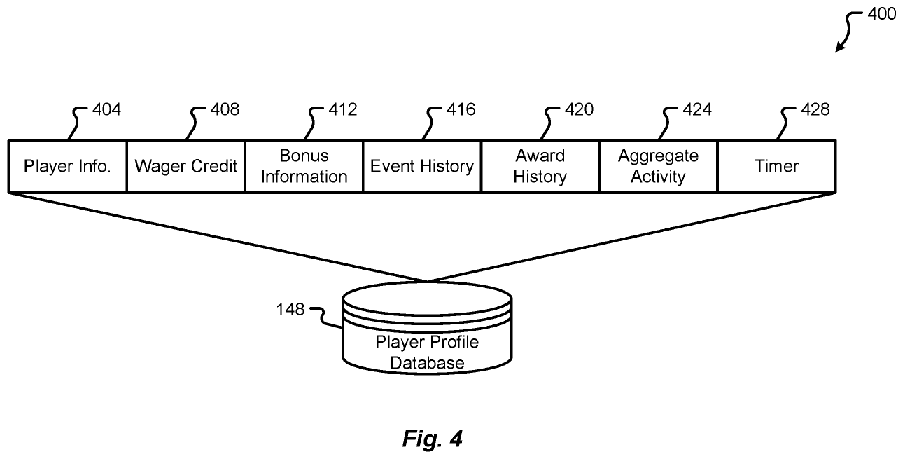

With reference now to FIG. 4, additional details of data that may be stored in the player profile database 148 will be described in accordance with at least some embodiments of the present disclosure. The database 148 may be configured to store one or multiple data structures 400 that are used in connection with tracking player progress with respect to particular events as well as a plurality of events. In some embodiments, the data stored in the data structure 400 may be stored for a plurality of different player profiles or for a single player profile. As a non-limiting example, the data structure 400 may be used to store player loyalty information, player history information, and the like. Even more specifically, the data structure 400 may include a plurality of data fields that include, for instance, a player information field 404, a wager credit field 408, a bonus information field 412, an event history field 416, an award history field 420, an aggregate activity field 424, and a timer field 428.

The player information field 404 may be used to store any type of information that identifies a player or a group of players. In some embodiments, the player information field 404 may store one or more of username information for a player 112, password information for a player account, player status information, accommodations associated with the player 112, and any other type of customer service management data that may be stored with respect to a player 112.

The wager credit field 408 may be used to store data about a player's 112 available credit with a casino or a plurality of casinos. For instance, the wager credit field 408 may store an electronic record of available credit in the player's account and whether any restrictions are associated with such credit. The wager credit field 408 may further store information describing a player's available credit over time, cash out events for the player, winning events for the player, and the like.

The bonus information field 412 may be used to store information describing bonuses that have been paid to the player 112 or that are available to be paid in response to particular events occurring within the gaming system 100, 200. As a non-limiting example, the bonus information field 412 may be used to store electronic records for values of awards that are available to or have been paid to the player 112. Even more specifically, the bonus information field 412 may store values of awards that will be paid to the player 112 if a particular event occurs within a predetermined amount of time (as monitored by a timer value in the timer field 428) and to store a value of an award that will be paid to the player 112 if a plurality of events occur. In some embodiments, a value representing a predetermined award for a single event occurring may be less than a value representing a predetermined award for a plurality of events occurring. The bonus information field 412 may also be used to store probability information or odds associated with a particular event occurring or a plurality of events occurring. In some embodiments, the probability of a single event occurring within the gaming system 100 may be greater than a probability of a plurality of events occurring, regardless of whether or not the plurality of events include the single event.

The event history field 416 may be used to store historical data for events that occur with respect to the player 112. Any event or plurality of events having an associated probability of occurrence or award associated therewith (e.g., based on the event being defined within the bonus information field 412) may have a corresponding entry within the event history field 416. For instance, the event history field 416 may store a definition of events and whether or not a particular event belongs to a plurality of events eligible for a jackpot bonus as discussed herein. Each event defined within the event history field 416 may further include an associated indicator to show whether the event has occurred or not and, if the event has occurred, when the event occurred. Some particular, but non-limiting events, may include a player's 112 outcome in a game of chance, a player's 112 outcome in a game of skill, a celebration event for a person other than the player 112, a player's 112 involvement in a celebration event, a player 112 visiting a predetermined location, a player 112 playing a particular game, a player interacting with their mobile device 216, etc.

The award history field 420 may store data related to awards, bonuses, mini bonuses, jackpots, etc. granted to the player 112. The award history field 420 may also indicate when such awards were granted to the player 112, whether the awards have been redeemed, whether the awards are being funded by a game of chance or skill, a mini bonus associated with an event, or a jackpot award associated with the player 112 completing a plurality of events.

The aggregate activity field 424 may also be used to store event information related to a plurality of events that are to occur if the player 112 is to win a jackpot award or the like. Furthermore, the aggregate activity field 424 may store information related to wagers placed by a player 112 in connection with trying to complete the plurality of activities and whether any portions of such wagers are being used to fund a jackpot pool associated with other players trying to complete the same plurality of activities within the same predetermined amount of time.

As discussed above, the timer field 428 may be used to store a timer value associated with tracking whether or not a particular player 112 has completed a particular event or a plurality of events within a predetermined amount of time. The value of the timer within the timer field 428 may count up, count down, or increment in any known way to track a passage of time. Alternatively or additionally, time may be measured by an occurrence of events within the gaming system 100, 200 rather than being measured absolutely. Specifically, the predetermined amount of time associated with determining whether a player 112 has completed an event or a plurality of events before some other player 112 within the system 100, 200 has completed the same event or plurality of events. Thus, the timer does not necessarily have to counting a passage of time with seconds and minutes, but rather may be counting a passage of time based on activities and events that occur within the system 100, 200. Such information may be maintained within the timer field 428.

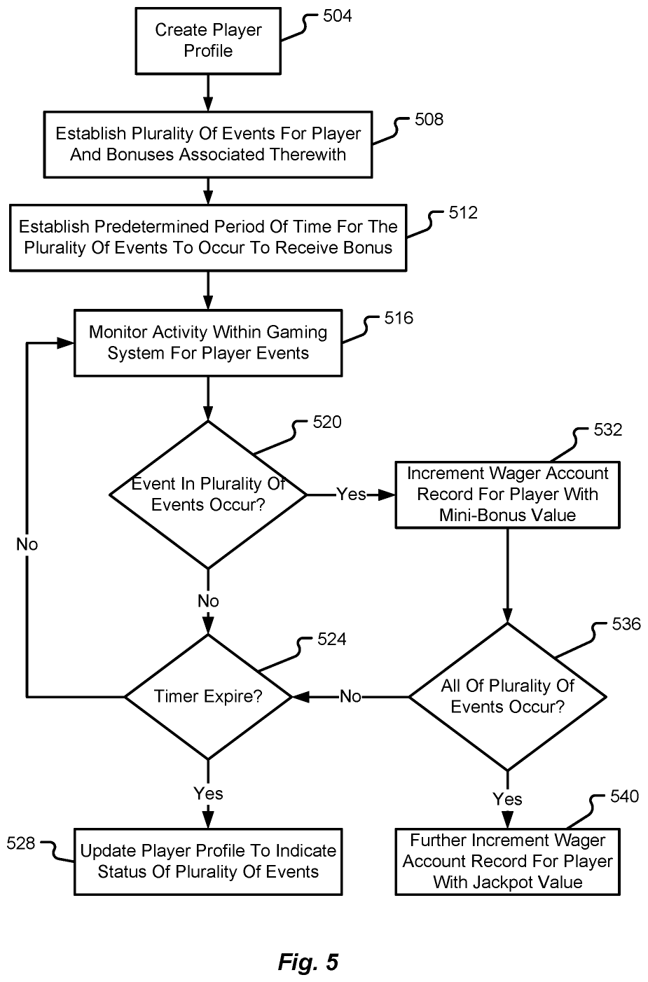

With reference now to FIG. 5, a method of performing bonus aggregation will be described in accordance with embodiments of the present disclosure. The method begins with the creation of a player profile (step 504). In some embodiments, a player profile may be created within the gaming system 100, 200 by a player management server, a bonus server, a bonus aggregation server, or some combination thereof. The player profile created in step 504 may include player identification information and a wager account record for the player 112. In some embodiments, the player identification information may include information stored in the player information field 404 and the wager account record for the player 112 may include information stored in the wager credit field 408, bonus information field 412, event history field 416, award history field 420, and/or aggregate activity field 424.

The method continues by establishing a plurality of events to occur for the player 112 and a first award that is associated with the player 112 completing the plurality of events (step 508). In some embodiments, the plurality of events may correspond to various types of events that can occur within the gaming system 100, 200 such as the player 112 visiting particular locations, playing particular games of chance, playing particular EGMs, playing particular table games, etc. Furthermore, the events in the plurality of events may be common to other players in the system 100, 200 that are competing with the player 112 for a jackpot pool (e.g., a progressive pool) or the like. Alternatively, one or more events in a first player's 112 plurality of events may be different from another player's plurality of events, even if the two players are competing for an award from a common progressive pool. The bonuses or awards associated with a particular event and the plurality of events may depend upon the probability associated with such events or plurality of events occurring and the bonuses may vary over time, especially if the jackpot bonus is paid out of a progressive pool or the like.

The method continues by establishing a predetermined period of time in which the plurality of events are to occur for a player to be awarded the jackpot bonus associated with completing the plurality of events (step 512). As mentioned above, this predetermined period of time may correspond to a fixed time period or may be measured by an occurrence of events within the gaming system 100, 200. As a non-limiting example, the predetermined period of time may correspond to a single hour, a 12-hour period of time, a 24-hour period of time, a 48-hour period of time, a week, a month, a year, or any other time window. In some embodiments, longer periods of time may be used only for players having a player membership or similar loyalty account for a casino whereas shorter periods of time may be used for players that do not have a player membership or loyalty account. The predetermined period of time may be tracked within the timer field 428 and may be greater than or less than a 24-hour period, thereby requiring a player 112 to visit a premises on two different days.

With the plurality of events defined and the predetermined period of time also defined, the method will continue by allowing the player 112 to engage in activities around a casino and monitoring the player's 112 activity within the gaming system 100, 200 for player events (step 516). This monitoring may occur via the EGMs 108a-N, table games 204a, 204b, network access points 208, and sensors 212. In some embodiments, various events at nodes in the system 100, 200 may be reported back to the bonus aggregation server 116 to help the bonus aggregation server 116 determine whether or not an event in the plurality of events has occurred (step 520).

If the query of step 520 is answered negatively, then the method continues by determining whether or not the predetermined amount of time has expired or lapsed (step 524). This particular step may be performed by referencing the timer field 428 and/or by determining that some other player in the system 100, 200 has completed the plurality of events defined for the player associated with the player profile created in step 508. If the query of step 524 is answered negatively, then the method returns back to step 516 to continue monitoring activities of the player 112 to determine if an event in the plurality of events has occurred. On the other hand, if the predetermined period of time has expired or lapsed prior to the player 112 completing all of the plurality of events, the player profile may be updated to indicate a status of the plurality of events for the player 112 (step 528). Specifically, the event history field 416 and/or award history field 420 may be updated to indicate that the player 112 has not completed all of the plurality of events within the predetermined period of time, but the player profile may also be updated to indicate which of the plurality of events were completed before expiration of the predetermined period of time. In some embodiments, specific fields in an electronic record representing a player profile may be updated within the database 148.

Referring back to step 520, if it is determined that an event within the predetermined plurality of events has occurred before expiration of the predetermined period of time, the method will continue by incrementing a wager account record for the player 112 with an appropriate value (step 532). In some embodiments, the wager account record for the player 112 may be updated by incrementing wager credits available to the player 112 within the wager credit field 408. Alternatively or additionally, a voucher may be issued to the player 112 and an electronic record representing the voucher may be updated. The updates may be performed within the database 148 and/or at an EGM 108. In some embodiments, where the event corresponds to one, but not all, of the events in the plurality of events, the wager account record for the player 112 may be updated with a mini bonus value, which is smaller than the value that could be assigned to the player 112 if the player completed all of the plurality of events.

Thus, the method will continue by determining whether or not the player 112 has completed all of the plurality of events within the predetermined period of time (step 536 and/or 524). If the query of step 536 is answered negatively, the method may eventually return back to step 516. Conversely, if the player 112 is determined to have completed all of the plurality of events within the predetermined period of time, the method may continue by further incrementing the wager account record for the player 112 with an additional jackpot value associated with the plurality of events being completed (step 540). As can be appreciated, the additional jackpot value may correspond to a predetermined value or may correspond to a value determined by a progressive pool used to coordinate player involvement with the plurality of events. In embodiments where the progressive pool is used, the value paid to a player 112 from the progressive pool may depend upon the size of the progressive pool at the time of performing step 536. Furthermore, the progressive pool may be funded by other players also trying the complete the plurality of events within the predetermined period of time. This means that one or multiple players may complete the plurality of events within the predetermined period of time. If multiple players complete the plurality of events within the predetermined period of time, the values assigned to each wager account record for each successful player may depend upon the number of players that completed the plurality of events. Alternatively, if there are multiple winning players, it may be possible to implement a drawing event or the like where a casino selects one of the qualified players to receive the entirety of the prize from the progressive pool.

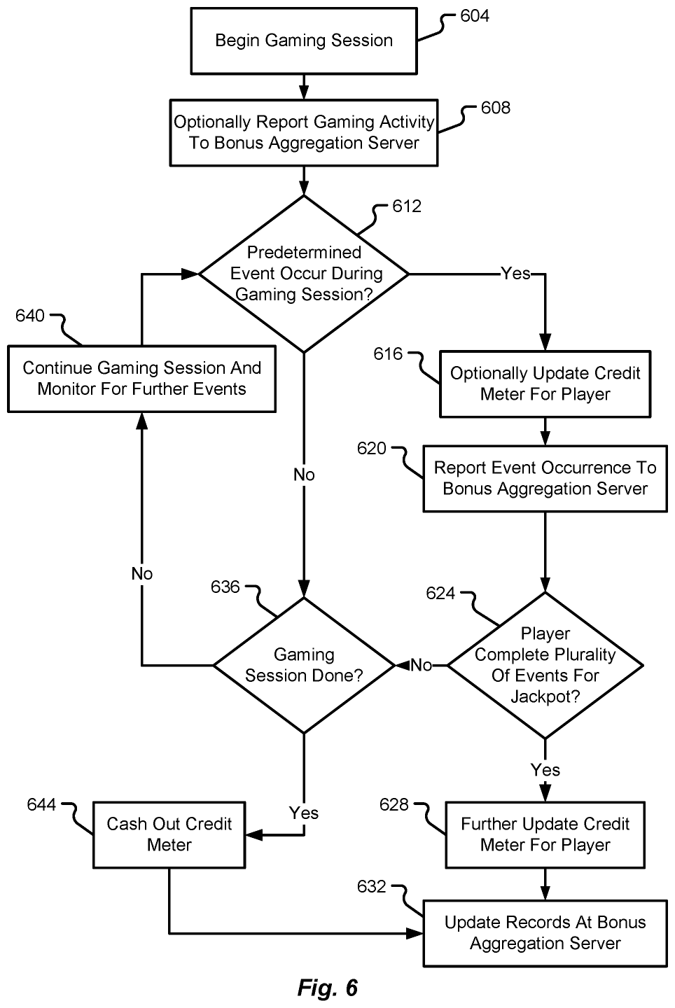

With reference now to FIG. 6, another method of performing bonus aggregation will be described in accordance with embodiments of the present disclosure. The method begins when a player 112 initiates a gaming session at an EGM 108, table game 204, and/or mobile device 216 (step 604). The player 112 activity as the device facilitating the game interaction may optionally report back to the bonus aggregation server 116 that the player is participating in the gaming session (step 608).

The method may continue with the device executing a game instruction set to enable the player 112 to participate in a game of chance, a game of skill, or the like. The device may execute event reporting instructions 328 to determine if a predetermined event has occurred during the gaming session that should be reported back to the bonus aggregation server (step 612). If the query of step 612 is answered negatively, then the method may continue by determining whether or not the gaming session is completed (step 636). If the gaming session is not completed, then the player 112 may be allowed to continue the gaming session and the player 112 activity may continue to be monitored for the occurrence of an event in a plurality of events (step 640). If the gaming session is completed, then the player 112 may be cashed out by the device, the credit meter 324 on the device may be appropriately updated, and the player profile database 148 may also be appropriately updated (step 644). In some embodiments, records maintained at the bonus aggregation server 116 may be updated to indicate that the player 112 has participated in the gaming session, but has yet to complete all of the plurality of events (step 632).

Referring back to step 612, if it is determined that a predetermined event in the plurality of events has occurred during the gaming session, the method may continue by updating a credit meter 324 based on the player's 112 achievement of the event (step 616). It should be appreciated that the updating of the credit meter 324 may be optional and can specifically depend upon the nature of the device that the player 112 is using for the gaming session. The method may further include reporting the event occurrence back to the bonus aggregation server (step 620). In some embodiments, the bonus aggregation server 116 may receive and process the reporting notification with the event recognition instruction set 132.

The method may then continue with the bonus aggregation server 116 determining whether or not the player has completed all of the plurality of events required to earn the jackpot award (step 624). If not, the method returns to step 636. If the query of step 624 is answered positively, then the method may continue by further updating the credit meter 324 at the device based on the player's 112 success (step 628). Thereafter, before, or in parallel with step 628, the player profile data structure 400 may also be updated by the bonus aggregation server 116 to reflect the fact that the player 112 has completed the plurality of events within the predetermined period of time (step 632).

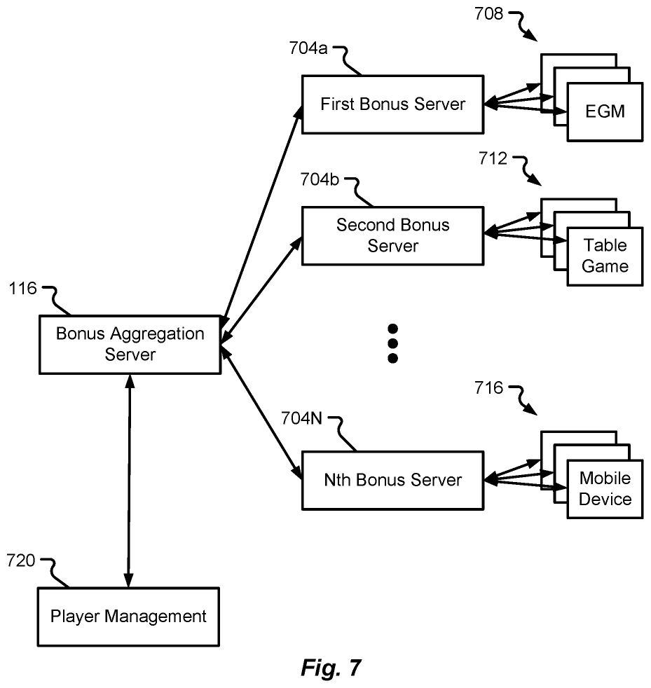

With reference now to FIG. 7, additional details of a gaming system will be described in accordance with embodiments of the present disclosure. It should be appreciated that the components shown in FIG. 7 may be provided as part of the gaming system 100 and/or 200 without departing from the scope of the present disclosure. In this illustrative configuration, the bonus aggregation server 116 is in communication with a plurality of different bonus servers 704a-N. The communication between servers 704a-N and the bonus aggregation server 116 may be achieved through use of the communication network 104.

Each bonus server 704a-N may be configured to manage individual bonuses paid out by a particular set of machines. As a non-limiting example, a first bonus server 704a may be in communication with a set of EGMs 708 and may manage bonus activities for the set of EGMs 708. A second bonus server 704b may be in communication with a set of table games 712 and may manage bonus activities for the set of table games 712. An Nth bonus server 704N may be in communication with a set of mobile devices 716 and may manage bonus activities for the set of mobile devices 716.

As shown in FIG. 7, each of the bonus servers 704a-N may be in communication with the bonus aggregation server 116. In some embodiments, the different bonus servers 704a-N may be configured to report bonus hit notifications to the bonus aggregation server 116. The bonus hit notifications may correspond to reporting communications that report an occurrence of a predetermined event in a plurality of events being managed and monitored by the bonus aggregation server for purposes of distributing a jackpot bonus. The bonus aggregation server 116 may then be configured to communicate with the player management server 720, again by the communication network 104. Communications between the bonus aggregation server 116 and player management server 720 may include communications regarding a player's 112 progress toward completing a plurality of events, whether a player has completed one, some, or all events in the plurality of events, and whether the predetermined period of time has expired or lapsed.

Thus, the configuration shown in FIG. 7 may correspond to an architecture where some components of the bonus aggregation server 116 depicted in FIG. 1 are distributed amongst a plurality of servers, such as the player management server 720 and individual bonus servers 704a-N. In some embodiments, the individual bonus servers 704a-N may be configured to monitor for individual predetermined events and further issue bonuses associated with the occurrence of those individual predetermined events. The bonus aggregation server 116, on the other hand, may be responsible for determining whether the plurality of events have occurred for a player 112 within a predetermined period of time. Thus, the bonus aggregation server 116 may be responsible for issuing jackpot bonuses, awards from a progressive pool, or the like based on a player 112 or group of players completing a plurality of events within a predetermined period of time.

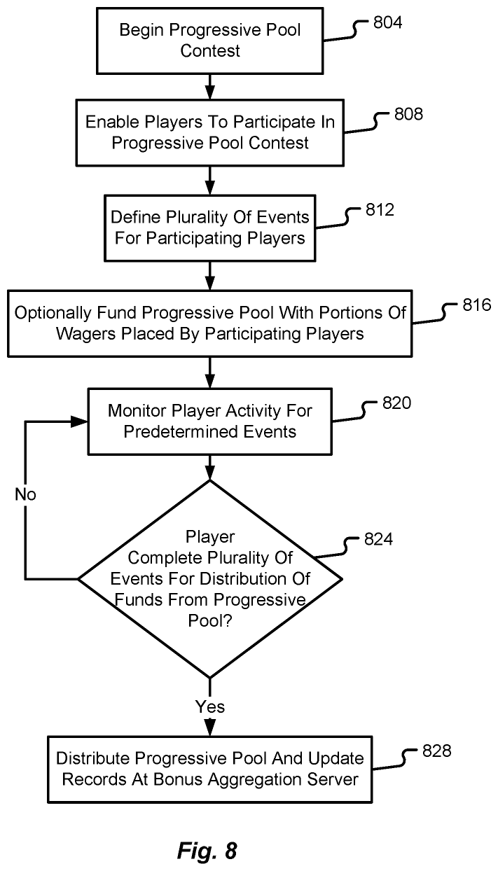

With reference now to FIG. 8, another method of performing bonus aggregation will be described in accordance with embodiments of the present disclosure. The method depicted in FIG. 8 may correspond to a bonus aggregation method performed in connection with a progressive prize pool or the like. The method begins with the initiation of a progressive pool contest (step 804). The progressive pool contest may be conducted within a single casino or across multiple casinos, which may or may not be owned by a common entity.

The method continues by enabling players 112 to participate in the progressive pool contest (step 808). In some embodiments, player participation may be conditioned upon a player having a membership or loyalty account with a particular casino. In other embodiments, player participation may be conditioned upon the player engaging with predetermined devices, which may be distributed across the different sets of devices 708, 712, 716. In some embodiments, players may be allowed to contribute in the progressive prize pool by contributing higher wagers to a game of chance or skill played at a particular device. Further still, players 112 may be asked to join the progressive game prior to the player 112 engaging a gaming device or after the player has completed a first event in the plurality of events. Thus, the method may further include defining a plurality of events for players participating in the progressive pool contest (step 812). The plurality of events for participating players may be common to all players or may be different for some players as long as the probability of the plurality of events occurring is approximately or exactly the same across different sets of plurality of events.

The method then further continues with the optional funding of the progressive prize pool with portions of wagers placed by the participating players (step 816). Alternatively or additionally, the progressive prize pool may be funded by casinos having games in a set of games 708, 712, 716. Alternatively or additionally, participating casinos could identify a fixed portion of the mini bonuses being distributed by the bonus servers 704a-N that enter into the progressive prize pool. A casino could also try to specify different levels of contribution based on a size of mini bonus paid to a player in response to a single event occurring. For instance, smaller mini bonuses may contribute a higher percentage to the progressive prize pool as compared to larger mini bonuses.

The method then continues by monitoring player activity among all of the participating players (step 820). In particular, player activity may be monitored at the bonus aggregation server 116 to determine if any of the participating players have completed all of the plurality of events defined in step 812 (step 824). If the query of step 824 is answered negatively, then the progressive pool contest continues back at step 820. This process continues until a participating player is determined to have completed the plurality of events at step 824. Once this occurs, the player(s) 112 that completed the plurality of events within the predetermined period of time (e.g., before expiration of a timer or before any other player completed the plurality of events), may receive wager credit or have an award paid out from the progressive pool (step 828). In some embodiments, records at the bonus aggregation server 116 and/or player management server 720 may be updated to reflect which player(s) 112 received funds from the progressive pool, the value of funds distributed to the player(s) 112, timing of distribution, etc. Furthermore, electronic wager account records may be updated for winning players to provide the winning players with additional wager credits or vouchers, as appropriate.

Alternatively or additionally, rather than waiting for a particular player to complete the plurality of events predefined for that player, embodiments of the present disclosure also contemplate paying out a best-performing player with respect to the plurality of events over a time period. Thus, it may not be required that a player complete all of the plurality of events, but rather that the winning player complete more of their plurality of events as compared to other participating players (e.g., more by total number, more by ratio, and/or more by lowest probability of the plurality of events occurring). Once funds from the progressive prize pool have been distributed, the method may start over and the aggregation of funds back into the progressive prize pool may recommence. Thus, distribution of funds from the progressive prize pool may be based on a particular player performing a predetermined plurality of events or based on the player achieving more than other participating players.

In various embodiments and as a non-limiting example, for distribution of a bonus aggregation award, a casino can specify the amount of the award based on the combination of mini bonuses a player wins within the predetermined period of time rather than simply paying or not paying a total progressive prize pool or large, predetermined jackpot value. For example, a player can get 1 million dollars if the player wins a particular mini bonus three times and each bonus is above a threshold value (e.g., $1,000). Meanwhile, if that same player wins a particular mini bonus three times based on celebration events occurring within the same period of time, then the player may win ten thousand dollars because the probability of the player winning the celebration bonus three times is greater than the player winning the mini bonus above the threshold value three times in the same period of time.

It should be appreciated that the various methods and systems described herein may be attractive to casinos because the bonus aggregation can be used to increase player loyalty by providing players with an opportunity to win larger awards based on the player's bonus award history. The methods and systems disclosed herein are attractive to players because the players are given more and different opportunities to win aggregated bonuses of various sizes, which may depend upon probabilities of events occurring within a gaming system or game of chance.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The invention is claimed as follows:

1. A method of bonus aggregation, the method comprising:
creating, by a gaming system, a player profile comprising player identification information and a wager account record for a player;
establishing, by the gaming system, a plurality of events to occur for the player;
establishing, by the gaming system, a predetermined period of time in which, if the plurality of events occur, the wager account record for the player will be incremented by a value representing a first predetermined award;
determining, by the gaming system, that a first event in the plurality of events occurs for the player within the predetermined period of time;
in response to determining that the first event occurs for the player within the predetermined period of time, incrementing, by the gaming system, the wager account record for the player by a value representing a second predetermined award that is less than the value representing the first predetermined award; and
updating, by the gaming system, the player profile to indicate that the first event occurred for the player within the predetermined period of time.

2. The method of claim 1, further comprising:
determining, by the gaming system, that the plurality of events has occurred for the player within the predetermined period of time; and
in response to determining that the plurality of events has occurred for the player within the predetermined period of time, incrementing, by the gaming system, the wager account record for the player by the value representing the first predetermined award.

3. The method of claim 2, wherein a probability of the first event occurring is more than a probability of the plurality of events occurring for the player within the predetermined period of time.

4. The method of claim 1, further comprising:
determining, by the gaming system, that the predetermined period of time has passed without the plurality of events occurring for the player; and
in response to determining that the predetermined period of time has passed, updating, by the gaming system, the player profile to indicate that the plurality of events did not occur for the player and that the player is ineligible to receive the first predetermined award.

5. The method of claim 1, wherein the plurality of events comprise a first event for a first electronic gaming machine (EGM) and a second event for a second EGM that is different from the first EGM.

6. The method of claim 1, wherein the plurality of events comprise a first event for a table game and a second event for an EGM.

7. The method of claim 1, wherein the plurality of events comprise a celebration event for a person other than the player.

8. The method of claim 1, wherein the value representing the first predetermined award is at least partially funded based on an aggregate activity within the gaming system.

9. The method of claim 1, wherein the value representing the first predetermined award is at least partially funded by wagers placed by other players also attempting to achieve the plurality of events within the predetermined period of time.

10. A bonus aggregation server, comprising:
a communication interface that facilitates machine-to-machine communications;
a processor coupled to the communication interface; and
a computer-readable storage medium coupled to the processor and comprising instructions that are executable by the processor, wherein the instructions comprise:
a set of instructions that receive event information related to events that occur within a gaming system;
a set of instructions that manage an electronic record representing a player profile within the gaming system; and
a set of awarding instructions that update the electronic record with a first value representing a first predetermined award if a predetermined plurality of events are determined to occur for a player within the gaming system, wherein the set of awarding instructions also update the electronic record with a second value representing a second predetermined award if a first event in the plurality of events occurs within a predetermined period of time, wherein the second value representing the second predetermined award is no larger than the first value representing the first predetermined award.

11. The bonus aggregation server of claim 10, wherein the predetermined period of time is greater than twenty-four hours and wherein the predetermined plurality of events comprise the player visiting a premises on a first day as well as the player visiting the premises on a second day.

12. The bonus aggregation server of claim 10, wherein the predetermined plurality of events comprise an outcome of a game of chance within the gaming system.

13. The bonus aggregation server of claim 12, wherein the game of chance is played at an EGM and wherein the outcome comprises a first outcome whose probability of occurring is greater than a probability of a second outcome occurring within the gaming system.

14. The bonus aggregation server of claim 10, wherein the first value representing the first predetermined award is incremented to the player profile in response to the predetermined plurality of events occurring within the predetermined period of time for the player or in response to a single event occurring within the predetermined period of time for the player, and wherein a probability of the single event occurring is more than a probability of the predetermined plurality of events.

15. A system, comprising:
a communication interface that facilitates communications with a plurality of EGMs;
a processor coupled to the communication interface; and
a computer-readable storage medium coupled to the processor and comprising processor-executable instructions that, when executed by the processor, cause the processor to:
receive event information related to events that occur within a gaming system;
manage an electronic record representing a player profile within the gaming system; and
update the electronic record with a first value representing a first bonus in response to a first event occurring for a player within the gaming system, update the electronic record with a second value representing a second bonus in response to a second event occurring for the player within the gaming system, and update the electronic record with a third value representing a jackpot award in response to determining that a plurality of events occur for the player within the gaming system and within a predetermined period of time, wherein the plurality of events include the first event and the second event.

16. The system of claim 15, wherein a probability of the first event occurring is greater than a probability of the plurality of events occurring, wherein a probability of the second event occurring is greater than the probability of the plurality of events occurring, and wherein the third value representing the jackpot award is greater than a sum of the first value representing the first bonus and the second value representing the second bonus.

17. The system of claim 15, wherein the first event relates to an outcome at a first EGM in the plurality of EGMs, wherein the second event relates to an outcome at a second EGM in the plurality of EGMs, and wherein information regarding the first and second event are received via the communication interface.

18. The system of claim 15, wherein the instructions further cause the processor to check player trip information for validation that the plurality of events occurred within the predetermined period of time.

19. The system of claim 15, wherein the plurality of events include a player history event and an event related to a game of chance in the gaming system.

20. The system of claim 15, wherein the plurality of events relate to the player visiting different EGMs as well as the player visiting predetermined locations within a premises.
